(19) United States
(12) Patent Application Publication
(10) Pub. No.: US 2005/0239538 A1
(43) Pub. Date: Oct. 27, 2005

(54) System and method for gambling video games

(76) Inventor: James Emerson Dixon, Los Angeles, CA (US)

Correspondence Address: BAY AREA INTELLECTUAL PROPERTY GROUP, LLC, PO BOX 210459, SAN FRANCISCO, CA, 94121-0459, US

(21) Appl. No.: 10/830,918

(22) Filed: Apr. 23, 2004

(51) Int. Cl. A63F 13/00

(52) U.S. Cl. 463/20

(57) ABSTRACT

An apparatus and method of implementing entertainment-oriented video games that payout winnings based on chance is provided. An embodiment of the apparatus includes a video game, a gambling game; and a game interface, which controls the playing of the video game unit based on the playing of the gambling game unit. Winnings in one embodiment are paid to a player based on a bet, odds resulting from playing the gambling game, and the performance of the player in the video game.

### FIELD OF THE INVENTION

The present invention relates generally to entertainment-oriented video games. More particularly, the invention relates to entertainment-oriented video games that include payouts based on chance.

### BACKGROUND OF THE INVENTION

Over the years, many games of chance have been devised to allow game players to wager a sum of money and have the opportunity to win greater sums of money. Such games include lotteries, bingo, keno, blackjack, poker, roulette, craps and slot machines. Of these games, many people find slot machines to be the most entertaining. There are at least two broad classes of conventional slot machines the mechanically operated type and the solid-state electronic type. Mechanical slot machines are widely known throughout the world. They typically have reels each with a plurality of symbols drawn on the surface of the reels, which are mechanically rotated to move and stop the symbol rows. The solid-state type typically uses a video display in which the symbols displayed on a CRT screen are electronically controlled to move. The video-type slot machine has various types. One of the types has three reels, and another has four reels. In the conventional slot machines described above, one slot machine is played by one player alone. While playing, the player of one machine does not communicate with the players of other machines. The players of the slot machines tend to play individual machines isolated from one another.

Mechanical slot machines typically have a number of rotary drums mounted on a common shaft so as to be individually rotatable thereabout with each drum being provided with an annular row of various signs or symbols, means for starting the rotation of the drums in response to actuation of a starting mechanism connected with an actuator handle, means operable to automatically stop the respective drums preferably at mutually different moments of time after the start of the drums, means for detecting the stop positions of the respective drums, and means for actuating a pay mechanism or other “winner indication means” in response to the drums stopping in positions corresponding to a specific winner combination of said stop positions as defined by a specific combination of said signs or symbols being shown in a window in the wall of the slot machine.

Originally, slot machines were generally of mechanical or at most electromechanical design wherein the deposit of a coin enabled activation of the machine. Due to the large number of repeated operations required by mechanical components, such machines require frequent maintenance and repair. The anti-cheat and anti-theft mechanisms of the prior art have also been found to be ineffective. Electronic slot machines where implemented to overcome these, and other, drawbacks to the mechanical slot machine.

Conventional solid-state electronic slot machine utilizes high-speed solid-state electronic circuitry for performing all of the functions performed by mechanical and/or electromechanical components utilized in conventional slot machines. Many types of electronic games have been developed and many resemble a slot machine. In the electronic slot machine, coins are inserted, a handle is pulled, symbol bearing reels visible through front viewing glass rotate and randomly stop in some predetermined order, identifiable winning combinations which are clearly marked pay back coins automatically, the entire process requiring a relatively short amount of time.

Another drawback of conventional slot machine is that the event that triggers a payout to the player is determined mainly by the winning combination of symbols, and the player cannot easily vary the program based upon his own choice or more complex gaming schemes. Furthermore, prior art slot machines typically are not adaptable to multiple play. Thus, the conventional slot machine is primarily adapted to but a single play for each actuation of the handle, although it is believed that many players would prefer multiple play, where a plurality of winning scenarios and events are available upon each actuation of the handle, if either the odds of winning were to increase proportionally or if a more exciting and stimulating game is provided to the game player.

An entertainment game technology that is well known to provide a very exciting and stimulating game experience to the game player is commonly known as “video games.” Video games are generally highly action and visually oriented, and come in a wide variety of platforms and game formats. Common platforms include dedicated video arcade consoles, personal computers, Internet game servers, and dedicated computer game consoles such as those made by Nintendo, the Sony Play Station, and many others. The range of video game formats is too large to enumerate, but include sports simulators, flight simulators, point and shoot, and fantasy action games.

Conventional commercial-grade video arcade consoles typically are a “pay per play” system available to the public where the game player inserts sufficient payment into the arcade console and plays the game either for a certain amount of time or until a certain metric, particular to the game, runs out; such as, game plays, fuel, weapons, etc. Typically, to continue playing payment must be made, and in some cases the game player may gain additional time of game play by achieving certain deterministic performance milestones; such as, a high enough score or hitting some other kind of target. Conventional video arcade consoles typically are played without any financial gain.

Personal computer video games operate on a similar principal as video arcade consoles, except the games are generally purchased as software, which is run on the general purpose personal computer hardware often located at the game player's non-public location. Moreover, the game software is typically purchased and is played continuously without any financial gain or loss. Personal computer video games may be networked locally or over the Internet to allow multiple players to interact with and compete against each other in the same game.

Internet based game servers exist where the game player is a thin client playing remotely in a game that is run on a central game server, and may be configured to enable players from anywhere in the world to play in the same video game in near real-time. Many flavors of this scheme exist were the game processing may be selectively done locally or remotely on the game server. The game server provider may require any sort of payment method including free, subscription based, and “pay per play.” Otherwise, known Internet server based games work similar to personal computer video games.

Know dedicated computer game consoles are similar to personal computer video games except they have special purpose game playing hardware, and typically the game resides in firmware (e.g., ROM cartages) that is inserted into the console to play the game, typically, on the game player's television. Moreover, the game firmware is typically purchased, or rented for a certain period, and is played continuously without any financial gain or loss. Dedicated computer game consoles may be networked locally or over the Internet to allow multiple players to interact with and compete against each other in the same game.

Action oriented video games heretofore have focused on providing a rich and complex sensory experience that challenges the game player's response times and decision making abilities, but lack the kind of excitement that gambling games like slot machines effectively provide. Known video game systems do not offer the rich and complex sensory experience like action-oriented video games and the chance of financial winnings like that of gambling games.

In view of the foregoing, there is a need for improved gaming techniques that both provide the sensory stimulation of video games and the chance to gain financial winnings as in gambling games like slot machines. It would also be highly desirable if the gaming improvement is simple for the player to utilize, was readily adaptable into current games, and is reliable in operation. By incorporating the technology of gambling games like slot machines into video game systems, a highly desirable new hybrid gamming experience could be achieved.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1a, b, and c illustrates front, side, and top views, respectively, of an embodiment of the present invention configured as a commercial-grade, Arcade Game Slot Machine console; FIG. 2 shows a system level block diagram of the software architecture according to a slot-machine embodiment of the present invention; FIGS. 3a and b shows a football based slot machine method according to an embodiment of the present invention;

FIG. 4 illustrates an embodiment of a default display prompt where the system is in a standby mode;

FIG. 5 illustrates an exemplary screen shot of a parameter selection request step of an embodiment of the present invention;

FIG. 5a shows an embodiment of a game parameter selection step where the player is prompted to select game parameters;

FIG. 5b illustrates how successive items of an exemplary game parameter list screen shot where game parameters are highlighted as the user scrolls through the list;

FIG. 6 illustrates a gambling game initiation example in accordance with an embodiment of the present invention;

FIG. 6a illustrates how conventional slot machine reels are incorporated according to an embodiment of the present invention;

FIG. 6b illustrates a handicap metric in accordance with an embodiment of the present invention;

FIG. 6b illustrates a handicap metric in accordance with an alternative embodiment of the present invention;

FIG. 7 illustrates a start game prompt that prompts the bettor to press a start button in accordance with an embodiment of the present invention;

FIG. 8a illustrates a football game play screen-shot in accordance with an embodiment of the present invention;

FIG. 8b illustrates a handicapping example in accordance with an alternate embodiment of the present invention;

FIG. 9 illustrates an example of a physical combat oriented video game in accordance with an embodiment of the present invention;

FIG. 10 illustrates an example of a survival, mission oriented video game in accordance with an embodiment of the present invention;

FIG. 11 illustrates an example of a time competition oriented video game in accordance with an embodiment of the present invention;

FIG. 12 illustrates an example of a weapons oriented video game in accordance with an embodiment of the present invention;

FIG. 13 illustrates an end of game prompt in accordance with an embodiment of the present invention;

FIG. 13a illustrates a “continue or cash out?” prompt in accordance with an embodiment of the present invention; and

FIGS. 13b and c illustrate a “progressive betting feature” in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, a variety of video game based, gambling apparatus and techniques are provided that are directed to entertainment-oriented video games that include payouts based on chance.

In one embodiment of the present invention, a gaming apparatus is provided that includes a video game unit, a gambling game unit; and a game interface unit, which is configured to communicate with both the video game unit and the gambling game unit such that the game interface unit can control the playing of the video game unit based on the playing of the gambling game unit. The gaming apparatus is further configured to pay winnings to a player playing the gaming apparatus based on signals from the game interface unit. Some applications may configure the video game unit to include the gambling game unit and the game interface unit. Some realized embodiments, implement the video game unit as a commercial-grade video arcade console and the gambling game unit as a slot machine of the mechanical or electronic type.

Alternative realized embodiments of the present invention implement the video game unit as a video arcade console, personal computer, Internet game server, or a dedicated computer game console. Likewise, typical video games implemented by some embodiments of the present gaming apparatus include video games like sports simulator, flight simulator, point and shoot, or fantasy action genres.

Depending on the particular application, winnings may be paid to the bettor in cash through a payout tray, or through electronic means. Alternative embodiments of the present gaming apparatus include gambling game like lotteries, bingo, keno, blackjack, poker, roulette, and craps.

The communication between the game interface unit and the video game unit may be any suitable means, as it depends on the particular implementation, but includes Internet, local area network, a wide area network, or wireless means.

A method of operating the gaming apparatus is also provided. In one embodiment of the method to operate the gaming apparatus, a bettor places an initial bet, the gambling game is played to produce an odds, a payout multiple is calculated based on at least the odds, at least one video game parameter is configured based at least on the odds, and then the play plays the properly configured video game to try to win payout winnings, and if the player wins the video game and selects not to continue, the bettor is paid winnings that are calculated based at least on the initial bet and the payout multiple. Alternative embodiments may also include the step of have the bettor select a first video game parameter, which additionally influences the video game's configuration during play.

Calculation of the payout multiple depends on the particular application, but some embodiments further based it on this video game parameter selected by the bettor. In particular, some embodiments calculate the winnings simply by multiplying the initial bet by the payout multiple.

How the flow of the video game and betting schemes proceed, again, depend on the goals and needs of particular application, but in some embodiments, if the player loses the video game, the video game simply ends and if, instead, the player wins the video game and selects to continue, the bettor may place another bet to continue playing again.

Particular implementations of the method may be for embodiments where the video game is a video arcade console and the gambling game is a slot machine of the mechanical or electronic type. Similarly, some embodiments may be for implementations where the video game is a video arcade console, personal computer, Internet game server, or dedicated computer game console.

Other features, advantages, and object of the present invention will become more apparent and be more readily understood from the following detailed description, which should be read in conjunction with the accompanying drawings.

### DETAILED DESCRIPTION OF THE EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments.

The present invention is directed to combining existing technologies from both the video game and the casino gaming industries into a single interactive video game system and method according to the teachings set forth herein. An aspect of the present invention is that virtually any conventional video game system may be adapted to incorporated desired features of conventional gambling game, thereby providing an interactive gambling game system that incorporates action oriented video games, such as those that are currently common in the video game industry, and is readily extensible to future video games as the technology evolves; e.g., virtual reality games.

The following embodiments will set forth the principles of the present invention in a variety of exemplary video arcade console implementations centered on a slot machine gambling approach. However, those in the art will recognize that a multiplicity of alternative conventional video game platforms may be adapted to work with a multiplicity of alternative conventional gambling games according to the principles taught by the arcade game slot machine embodiments presented below. By way of example, and not limitation, suitable video game platforms include dedicated video arcade consoles, personal computers, Internet game servers, and dedicated computer game consoles. Similarly, by way of example, and not limitation, suitable gambling games include lotteries, bingo, keno, blackjack, poker, roulette, craps and slot machines.

Hence, as those in the art will readily be able to extend the present teachings to the multiplicity of combinations of video game platforms and gambling games, for clarity, the present invention will be illustrated in the context of an arcade game slot machine embodiment.

Modem video games systems typically use a computer system to simulate a game environment, which includes a multiplicity of objects and/or characters controlled by the computer and one or more players. The players often compete against the computer and/or each other to achieve some kind of goal. The computer has complete control of all aspects of the game's simulated environment and typically offers various difficulty levels to challenge players. The higher the game difficulty level, the more skill the player requires to achieve a similar level of performance as that for lower difficulty levels. Moreover, the higher the difficulty level, the lower the odds are that the player will win the game. In some embodiments, the odds of winning the game may be based on some combination of playing odds and betting odds. Playing odds refers to the odds that the differing abilities of the bettor's player will win over the computer's player. For example, if a bettor's player is 3 times better, according to some metric, than the computer's player, then the playing odds are 3 to 1 in the bettor's favor. Betting odds, or payout odds, refer to the payout multiple, which is some multiple of the bet place by the bettor and is paid if the bettor wins the game. In some embodiments, the payout multiple is determined through the action of playing some game of chance, such as, for example, pulling a slot machine arm and randomly selecting symbols that are associated with certain levels of payout. Depending on the particular application, the game difficulty level set by the computer, in accordance with the principles of the present invention, may in some embodiments be based on the payout multiple.

There are many genre specific techniques known to those skilled in the art to increase the difficulty level of a video game. By way of example, and not limitation, video games like football may increase the difficulty level of the game by adjusting the skill level of the computer's team to change the odds of the game. Other game genres may implement alternate methods including, but not limited to:
A) Point Spreads—where winning is based on the Player or Computer first covering the point spread;
B) Total Points—where winning is based on the Player or Computer scoring a certain number of points;
C) Life Force—where winning is based on the Player or Computer having the most life force left at end of game;
D) Time Spreads—where winning is based on the Player or Computer completing within a certain time spread;
E) Total Time—where winning is based on the Player or Computer completing within a certain amount of time;
F) Goals—where winning is based on the Player or Computer achieving more goals within the games design structure; and
G) Goal Spread—where winning is based on the Player or Computer at least cover the goal spread within the game design structure.

The foregoing list is intended to be illustrative and not exhaustive. Moreover, in an aspect of the present invention, the existing difficulty level adjustment technique(s) of a video game are properly manipulated to integrate a gambling method in accordance with the principles set forth herein.

In the embodiments described below, a standard video game is adapted to accept a bet placed by a person, whereby the difficultly level of the game for the bettor is set to a certain configuration to correspond with a probability, or odds, of winning, which is determined by playing a standard gambling game; for example, by a slot machine's pseudo-random selection of symbols after pulling the slot machine arm. The odds of winning determines a certain payout multiple of the bettor's bet that the bettor may win upon winning the game.

Herein a person placing a bet into the gambling video game of the present invention is often referred to as a bettor. A player is often refers to the computer-generated character that the bettor plays as within the video game. Goals are often referred to as the given tasks or milestones within the video game that the player acts to achieve.

The present invention is contemplated to be adaptable to virtually all known video games. A comprehensive treatment of how all video games are adapted to work with the present invention is not practical. However, several typical game genres will be discussed in the context of embodiments of the present invention, whereby those skilled in the art will readily recognize how to apply these teachings to adapt the particular video game system in accordance with the principles of the present invention.

A first embodiment of the present invention includes game genres where points are the deciding factor to win; such as, for example, Football. In this case, the computer may set, for example, a point spread that the bettor's player(s) must beat the computer's player(s). That is, to have a winning score at a certain point in the game, the bettor must score at least one point more than the point spread amount plus the computer's score. For example, in one Football game embodiment of the present invention, the bettor makes a bet, picks a team, pulls a slot machine arm, payout odds are then set based on the bet amount and the random slot machine reels and other game specific details. And, if the bettor wins the game, he or she is paid winnings, which is some multiple of the bet based on the odds set by the slot machine.

A second embodiment of the present invention includes game genres where the bettor must beat a series of opponents (computer or other players) to win the game; such as, for example, fighting games like boxing or first person shooting games. In this kind of game genre, the computer may set the difficulty of the game by making adjustments, for example, to the computer's fighter skill level and the amount of life given to the computer's fighter. The computer can also adjust the different types of bonuses encountered within the game to either favor the bettor's fighter or the computer's fighter as appropriate. In the present embodiment, the bettor makes a bet, picks a fighter from a list of combatants, pulls a slot machine arm, and odds are set based on factors including, for example, the bet amount and the random selection of the slot machine reels and the computer's fighter skill or power level. The bettor has the option to either select an opponent or have the computer select one. The computer determines the corresponding game difficulty level and amount of life for the computer's fighter. Setting game difficulty level may include setting a time limit by which the bettor's player must defeat all opposing forces in order to move on to the next level. Other game difficulty level adjustments include providing opponents increased weapons, numbers, life span, physical abilities, etc. than that of the bettor's player. In the present game genre, the bettor's player may win, for example, either by defeating the computer's opponent, by having more life left after a time limit expires, or achieving a certain number of point to move on a next level.

A third embodiment of the present invention includes game genres where the player must beat a series of opponents or finish in a certain amount of time to win the game; such as, for example, race car oriented games. The computer may set the game's difficulty level by, for example, adjusting the computer's car power and handling ability and its driver's skill level. The computer may further implement some kind of handicap time interval that the bettor must win by to make the game more difficult for the bettor. In the present embodiment, the bettor makes a bet, picks a car from a list of automobiles, pulls the slot machine arm, and gambling odds are set based on the bet amount and the random selection of the slot machine reels and the cars the computer has selected as the bettor's opponents. The computer then determines the corresponding game difficulty level. In the present game genre, the bettor's car may win, for example, either by defeating the computer's opponents or by beating the time handicap limit, and thereby be paid winnings based on the payout multiple and the bet made. In some embodiments, the computer can also adjust the different types of bonuses encountered within the game to either favor the bettor's car or the computer's car.

A forth embodiment of the present invention includes game genres where the bettor must achieve more goals than the computer's player; such as, for example, in goal oriented games like dungeons and dragons. For a game like dungeons and dragons, a bettor's player must find a way through a maze and fight different enemies, dragons etc, and receives rewards for defeating them and finding the way to the end of the maze without dicing. By way of example of the present embodiment, the bettor places a bet, picks a player, pulls the slot machine arm, and if the better gets three lemons, for example, very favorable payout multiple would be given and the bettor would be favored. The computer then makes corresponding adjustments to the game difficulty level, which includes setting a high goal spread, such as six goals, within any given level of the game. In this example, the bettor's player must beat the computer and win six goals within the game's structure to move on to the next level or win the game, and thereby be paid winnings based on the payout multiple and the bet made. In another example, if a bettor gets 1 lemon, 1 orange and 1 cherry after pulling the slot machine arm, the computer may, in addition to other game difficulty level adjustments, make the bettor's player goal level relatively low, such as two goals. In this case, the bettor's player must achieve at least three goals to win the game or move on to the next level.

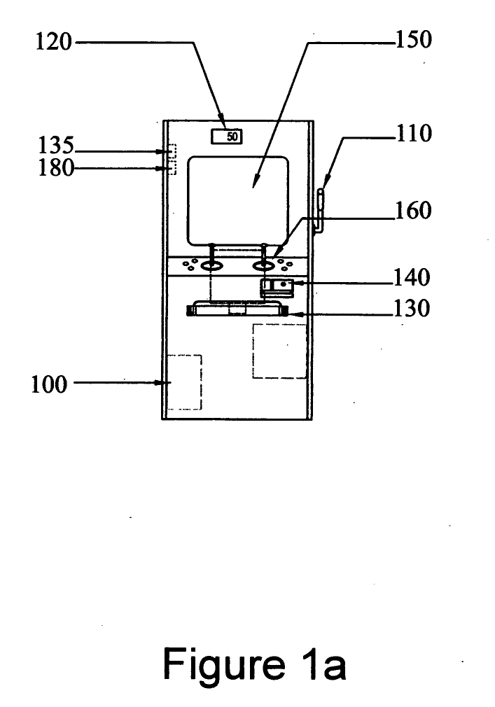

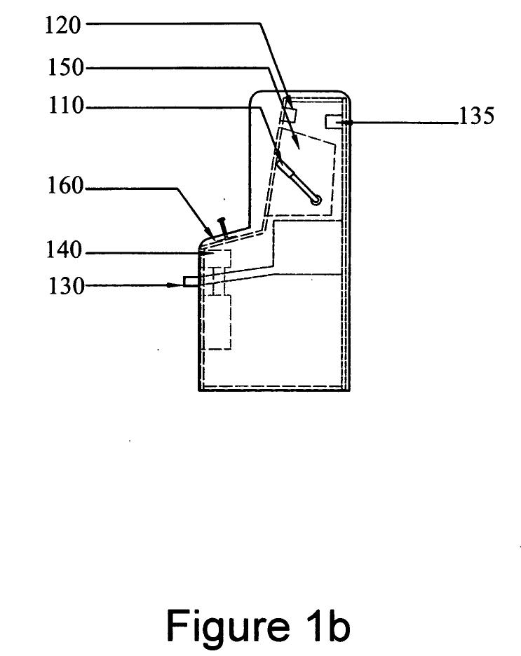

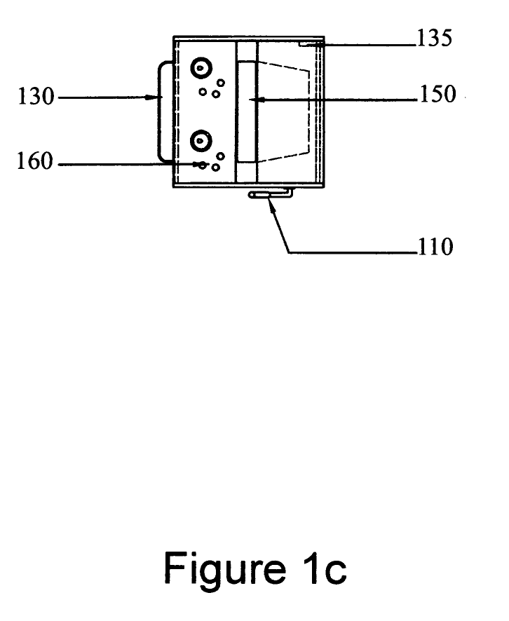

FIG. 1a illustrates a front view of an embodiment of the present invention configured as a commercial-grade, Arcade Game Slot Machine console 100. Game console 100 is structurally very similar to conventional arcade video game console with addition of some added elements as follows. The embodiment shown includes a slot machine style Pull Arm 110 located on 1 side, a credit meter 120, and a payout tray 130. To support the slot machine aspect of the present arcade video game the system is further configured to include a mechanical or electronic spinning reel mechanism (not shown), and a Game Interface Unit 135 that interfaces the existing video game system technology as implemented by a conventional Manufacturer's Game Computer (not shown, but executes the video game in a conventional video arcade game console) to the existing slot machine technology. The arcade video game is configured to enable the player to place a wager against the computer executing the preprogrammed video game as will be discussed in some detail below. The proper merging of these technologies to achieve interactive wagering integrated into standard video game platforms is well within those of ordinary skill in the art. Some implementations of the present embodiment may be enclosed in a steel secure enclosure instead of the common wood enclosure. It should be noted that other than the foregoing visible elements, there are no substantially visible differences that distinguish Arcade Game Slot Machine console 100 from any standard commercial-grade, arcade video game console. Similarly, furthermore, Arcade Game Slot Machine console 100 plays all the standard video games that are commonly available with little modification except to sufficiently support the wagering system and method of the present invention. Common video games include by way of example, and not limitation, Team sports games such as Football, Baseball, Basketball, Hockey, Soccer, etc., racing games like automobiles, snowboard, snow skiing, water skiing, motorcycles, etc., point and shoot games, etc., and classic video games of the past. Those in the art will envision a multiplicity of other video games that can be adapted to achieve an interactive wagering version of that video game in accordance with the teachings of present invention.

Arcade Game Slot Machine console 100 is includes a payment acceptor 140. Depending on the application, payment acceptor 140 may be a coin, bill, credit card, and/or smart card payment accepter means. In some alternative embodiments, payout tray 130 may not be included when the payout of any winnings to the player is solely by way of electronic credit, for example, and not limitation, to the credit card, smart card, or fund transfer to the player's bank account.

FIGS. 1b and 1c illustrate a side and top view of Arcade Game Slot Machine console 100 according to an embodiment of the present invention.

FIG. 2 shows a system level block diagram of the software architecture according to one slot-machine embodiment of the present invention, whereby Game Interface Unit 135 interfaces a gambling game unit 220 for seamless integration as taught by the present invention with a Manufacturer's Game Computer 210, which is a standard video game platform responsible for executing the video. Depending on the application, the software and/or hardware of Manufacturer's Game Computer 210 may have to be slightly modified to properly interact with Game Interface Unit 135. For aftermarket application, those skilled in the art will readily know how to adapt Manufacturer's Game Computer 210 to be retrofitted with Game Interface Unit 135 and slot machine unit 220. Similarly, original equipment manufactures will implement known design methodologies to readily configure the present invention into their existing video game platforms. It will be further readily recognized by those in the art, that Manufacturer's Game Computer 210 can be virtually any suitable video game platform. Likewise, it is further contemplated that beyond slot machines, gambling game unit 220 may be any kind of suitable game that is based on change and wagering.

FIGS. 3a and 3b shows a football based slot machine method according to an embodiment of the present invention. Each Step shown in the Figure will separately illustrated by way of an exemplary corresponding screen shot in the subsequently described Figures with reference continually to FIGS. 3a and 3b.

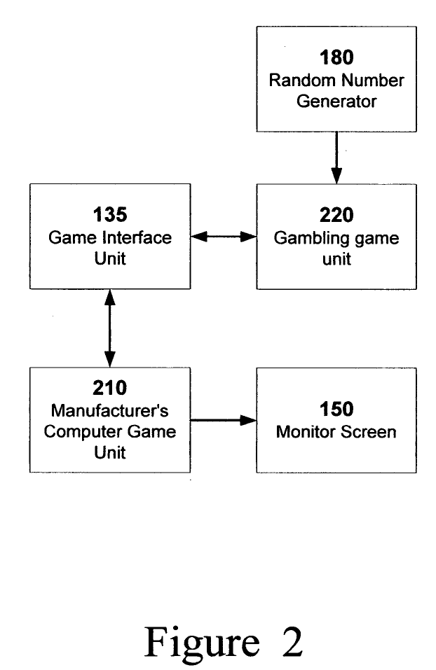

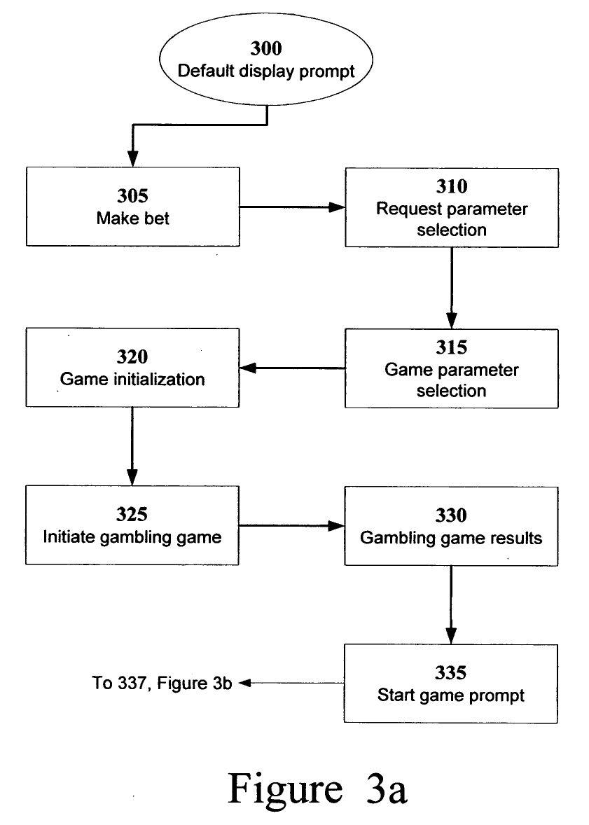

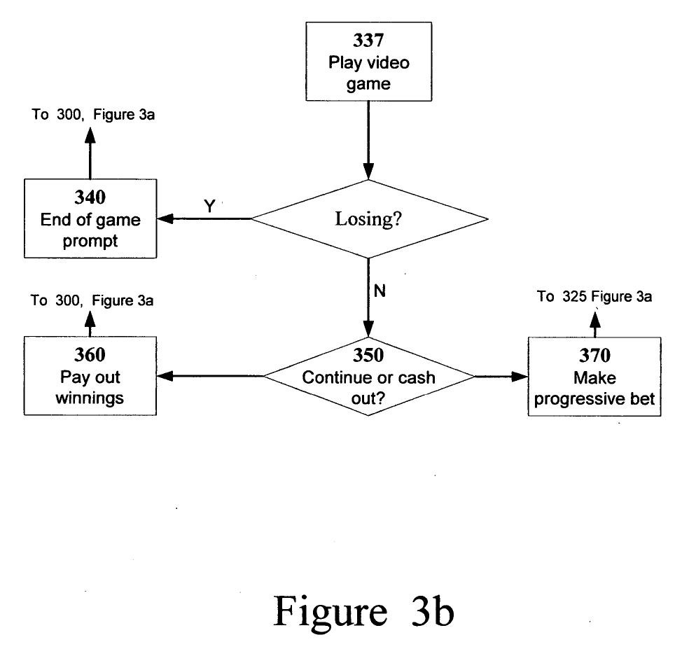

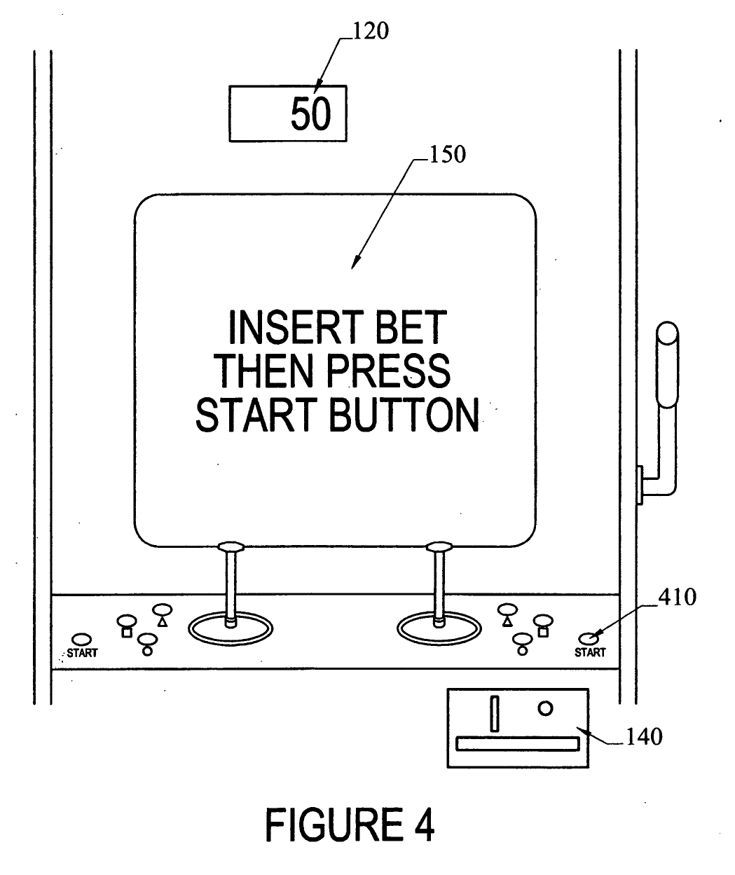

FIG. 4 illustrates an embodiment of a default display prompt at Step 300 where the system is in a standby mode, where Game Interface Unit 135 displays a message on a Monitor Screen 150 effectively communicating that the player should deposit payment into payment acceptor 140 to start playing the game. In one embodiment of the method to operate Arcade Game Slot Machine console 100, at Step 305 a player inserts a cash bet into payment acceptor 140, which is reflected on credit meter 120 by the Game Interface Unit 135, until a desired betting amount is reached, and presses Start Button 410 to proceed to begin a game initialization process. Upon payment validation, the Game Interface Unit 135 performs some initial tasks including the following, it: takes the game off stand-by mode, calculates the amount of the bet the player inserted into payment acceptor 140, and displays a prompt on Monitor Screen 150 for the player to press a Start Button 410 located on a Game Control Panel 160.

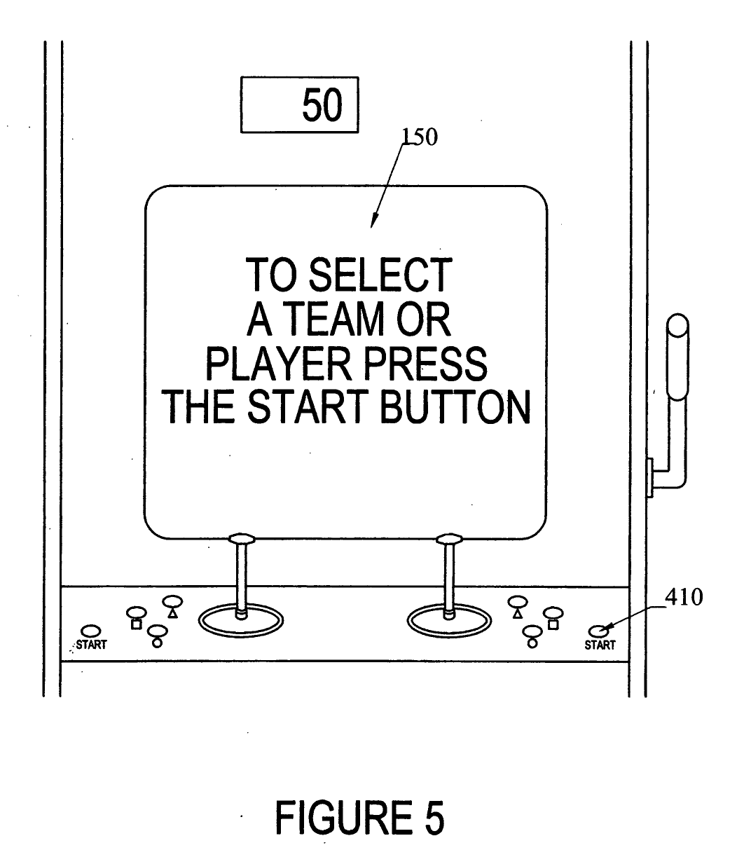

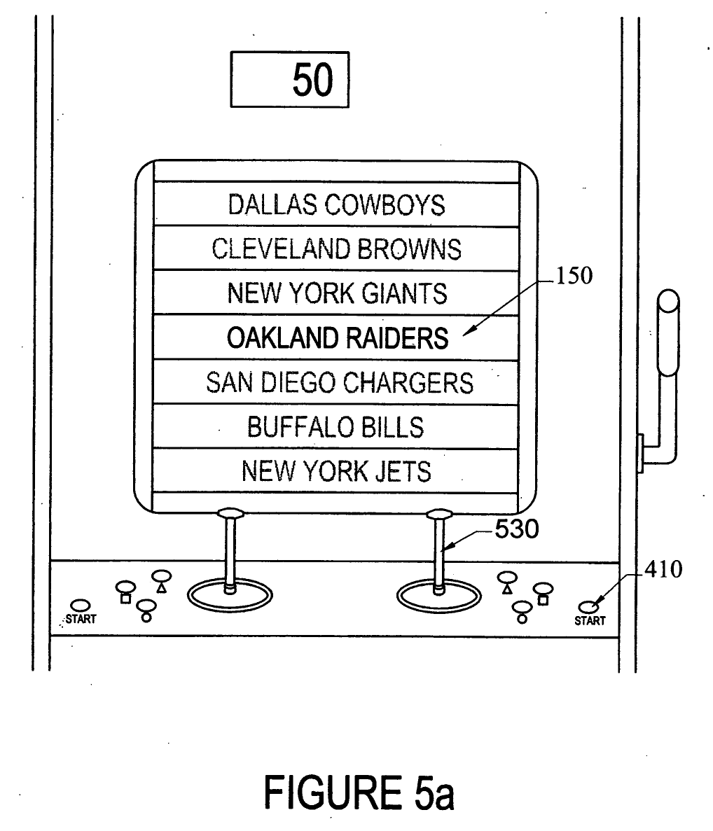

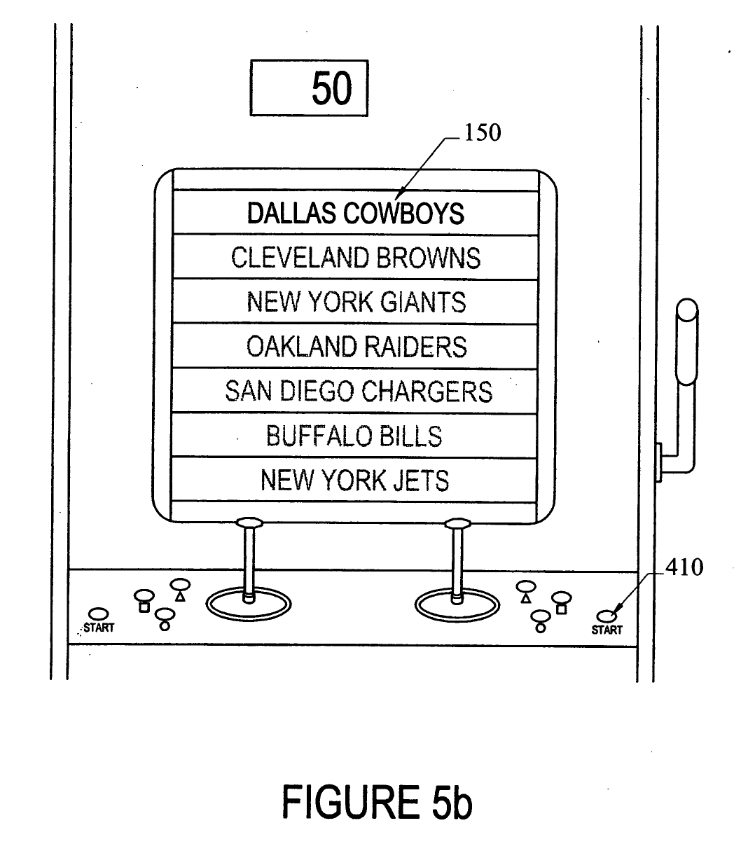

FIG. 5 illustrates an exemplary screen shot of Step 310 of the present embodiment. The displayed messaged effectively communicates that the player will be making game parameter selections next. Such informational messages may be displayed for a brief amount of time and automatically continue to the next step, or the player may be required to press a button, such as Start Button 410, to continue.

FIG. 5a shows an embodiment of Step 315 where the player is prompted to select game parameters from a list of options, such as teams, players, cars, or other game characters or attributes, depending on the particular game being played. The present embodiment is directed to a football video game example, however other types of video games will follow similar game configuration steps, and those in the art will readily recognize how to apply the present football game example teachings, to any video game. In the present example, a list of football teams 520 is displayed and the player can select the teach they wish to play as by using a Joystick 530 and buttons located Game Control Panel 160 to scroll through the list 520 as prompted on Monitor Screen 150. The current selection is shown as the fourth item in list 520 as an example, and successive items are highlighted as the user scrolls through the list as illustrated in FIG. 5b, where the first selection of the list is now highlighted after scrolling up the list.

The player makes the selection by pressing the Start Button 410, and in response Game Interface Unit 135 proceeds to Step 320 where it performs a multiplicity of game setup operations which includes, but is not limited to, selection of another team (player, car or other competitive character) from list of football teams 520 (i.e., list of players, cars or other competitive characters) that most closely matches the skill level or performance of the team (player, car or other competitive character) chosen by the player's selection from that list. In alternate embodiments of the present invention, the player may select the Manufacturer's Game Computer's team in lieu of Game Interface Unit 135 making the selection based on the most closely matched statistical team, player, figure etc.

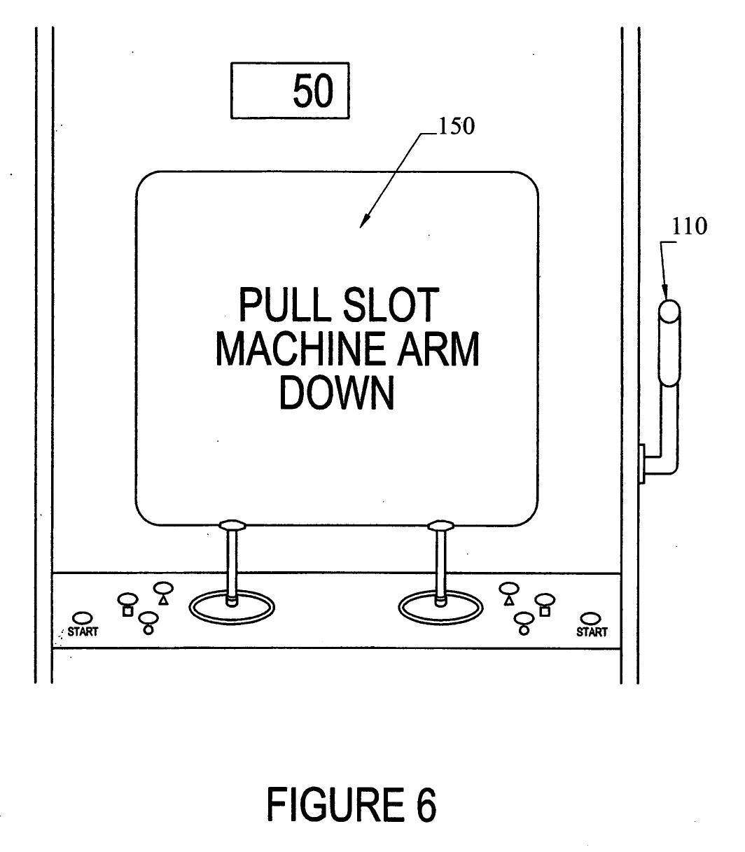

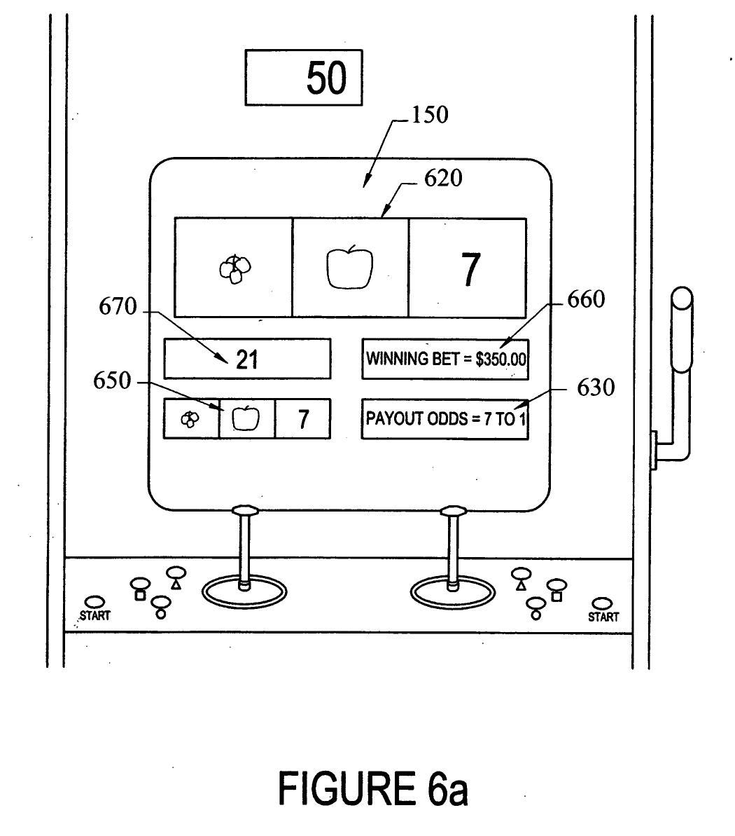

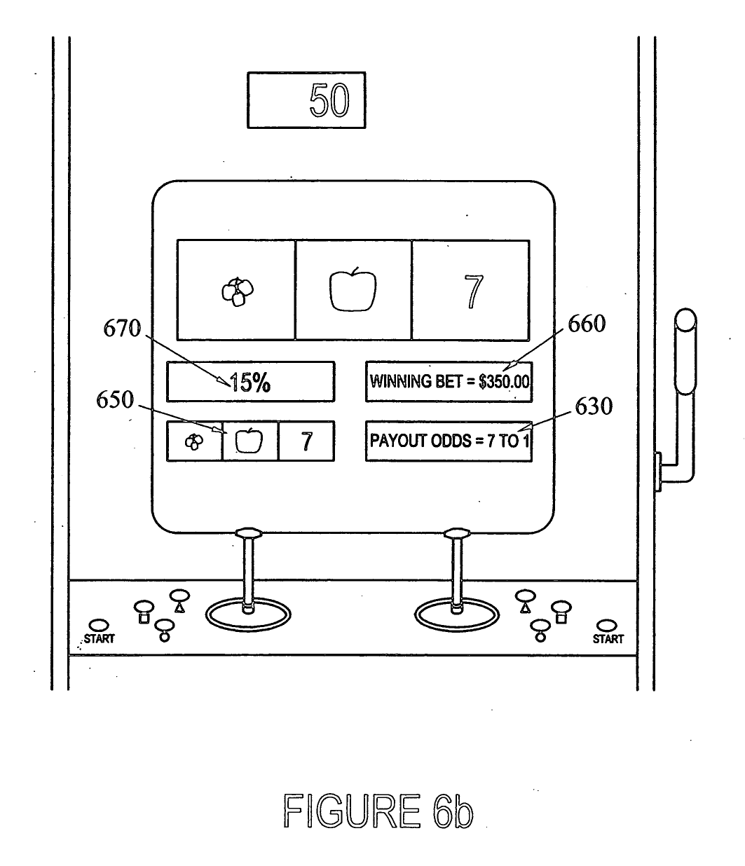

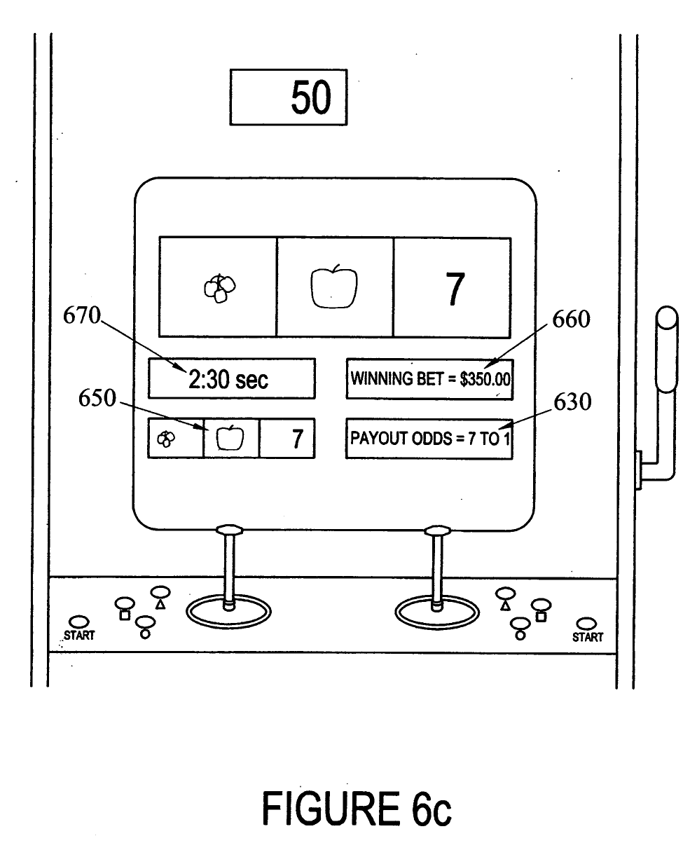

Step 325 is illustrated by way of example in the embodiment of FIG. 6, where Game Interface Unit 135 prompts the player on Monitor Screen 150 to pull down on Pull Arm 110 to initiate a slot machine portion (not shown) of the invention. After the player engages Pull Arm 110, Game Interface Unit 135 starts the Reel spinning process as shown by conventional slot machine Reels 620 in the embodiment of FIG. 6a (may be mechanical or virtual electronically implemented Reels) until each Reel 620 lands on a pseudo-random stop, as determined by the Random Number Generator 180 (see FIG. 2), which corresponds to a given symbol (For example, 2 lemons and 1 orange), similar to any conventional mechanical or electronic slot machine. Reels 620 and Random Number Generator 180 are well known to those skilled in the art, who will further readily recognize how suitable configure and integrate the slot machine portion into conventional video game consoles. Game Interface Unit 135 combines the slot machine results with a multiplicity of video game specific considerations to determine a ‘game adjustment’ calculation used to adjust the skill level or performance level of the team, player, car or other character that the Manufacturer's Game Computer, which is built into the conventional arcade video game console, will use to play against the player. Typically, Video Game Manufacturers design the games based on the Player's actual physical statistics or the actual characteristics of machines or other standards, whereby the present invention simply introduces additional factors for the standard computer skill level calculation to consider. Typical factors that are considered, include, but are not limited to:
a. The amount of the cash bet placed by the player into the payment acceptor 140 as represented in credit meter 120;
b. The team, player, car, or other character selected by the player and its associated skill, characteristic or mechanical level of performance as designed by the Game Manufacturers; and
c. A payout odds 630 given by the slot machine portion as a result of pulling pull arm 110 to spin the Reels, which determines the odds by stopping on a particular combination of symbols.

Referring to the embodiments shown in FIGS. 6a-c, after spinning slot machine Reels 620 have stopped on the random pattern of symbols, Monitor Screen 150 will display a group of gambling related windows below the reels at Step 330, which as shown in FIG. 6a may include a payout odds 630, a current spinning reel symbol pattern 650, and a potential payout amount 660. The present embodiment further is provided with a handicap 670 illustrated in FIGS. 6a-c, which is shown as a point spread in FIG. 6a, and a percentage of increase in skill, physical abilities, performance, goals, tasks, or other measuring system for handicapping the favored player in FIG. 6b. Another example of a handicap 670 is shown as time spread in FIG. 6c. Potential payout amount 660 is the amount that the winning bet would be based on the given gambling game results up to the present Step. Likewise, payout odds 630 are the odds as determined by the gambling game results at the present Step 330. The point spread is the number of points that the favored player must have over the less favored player at a certain milestone point in the video game. It should be noted that the favored player may be either the betting player or the Manufacturer's Game Computer 210 (FIG. 2) depending on the particular betting parameters selected at Step 315.

Referring simultaneously to both FIG. 1 a and FIG. 6a, in the present football example, the player selects to play a football version of the Arcade Game Slot Machine console 100 and may choose the winner of the previous Super Bowl. That is, the player has, in effect, chosen a team that the game designers have programmed with statistics from the previous year's Super Bowl winner, and accordingly that team will have a better skill level of any other team, which translates into lower odds that any remaining team that the Game Interface Unit 135 chooses for the Manufacturer's Game Computer to play with will win over the player's superior Super Bowl winning team. The Game Interface Unit 135 also takes into account the amount of the player's bet in credit meter 120, and payout odds 630 given by the slot machine portion. By way of example, and not limitation, the player may have inserted a large cash bet as reflected in credit meter 120 and pulled the pull arm 110 and received three lemons, which may be programmed to result in, for example, 7 to 1 payout odds against the players cash bet. Game Interface Unit 135, therefore, has to make some adjustments to even out the odds. Otherwise, for example, based solely on the original Video Game Manufacturer game design criteria, a skilled player using the best team could always easily beat the Manufacturer's Game Computer using an inferior team and win the bet. Many known methods exist to properly adjust the odds to optimize the payout of a gambling machine based on the particular factors of the application.

Referring again to FIG. 6b, to calculate handicap 670, Game Interface Unit 135 takes as input at least the gambling game results described above and based on a variable scale adjusts the skill level of the Manufacturer's Game Computer team and players, by, for example, handicapping their physical attributes, such as speed in the 40 yard dash, vertical jump, arm strength and other measured physical attributes to a factor ranging, for example, from a 1% to 10% increase. The adjustment to the Manufacturer's Game Computer team and players is implemented on a variable scale so that the player still has a chance of receiving a computer skill increase factor near the 1% range, thereby allowing for a more competitive game in which the player may still have the advantage over the Manufacturer's Game Computer's team and players. In some embodiments, the variable skill adjustment scale may be weighted to favor the Manufacturer's Game Computer team or players to give the “house” more favorable odds, similar to what is often done in casino slot machines. Those in the art will recognize a multiplicity of alternative gambling and handicapping techniques in light of the foregoing teachings.

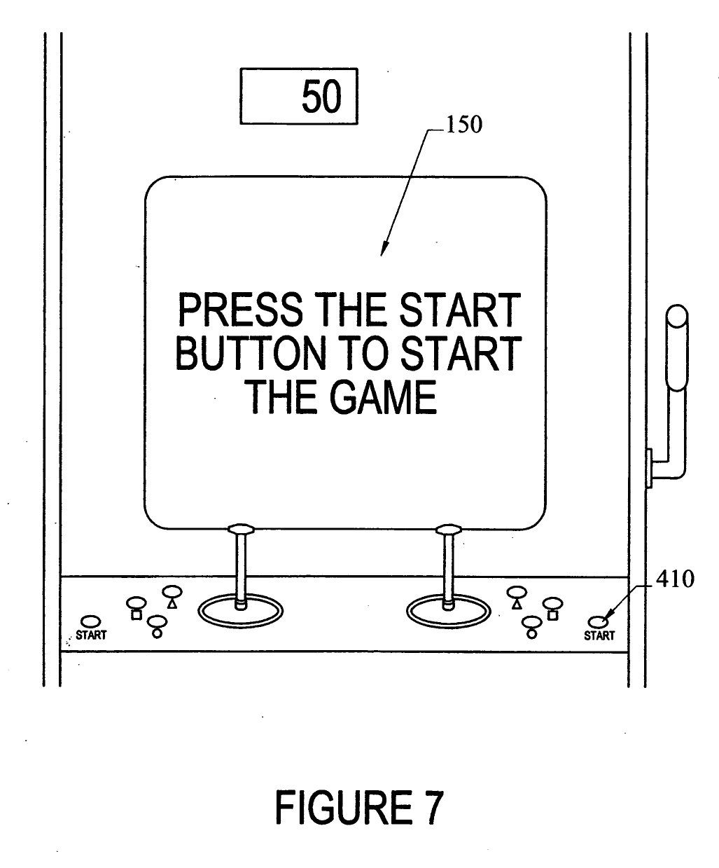

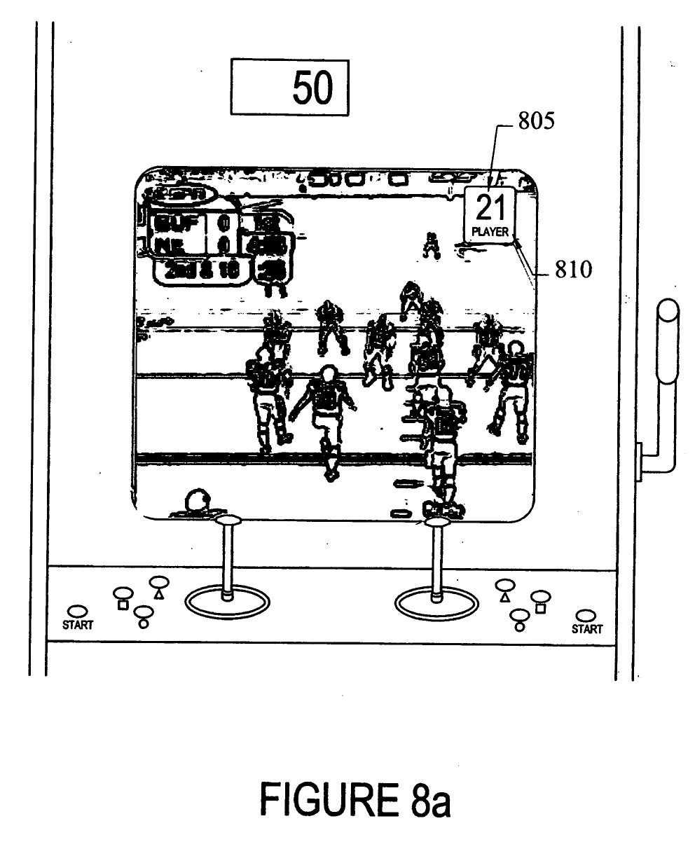

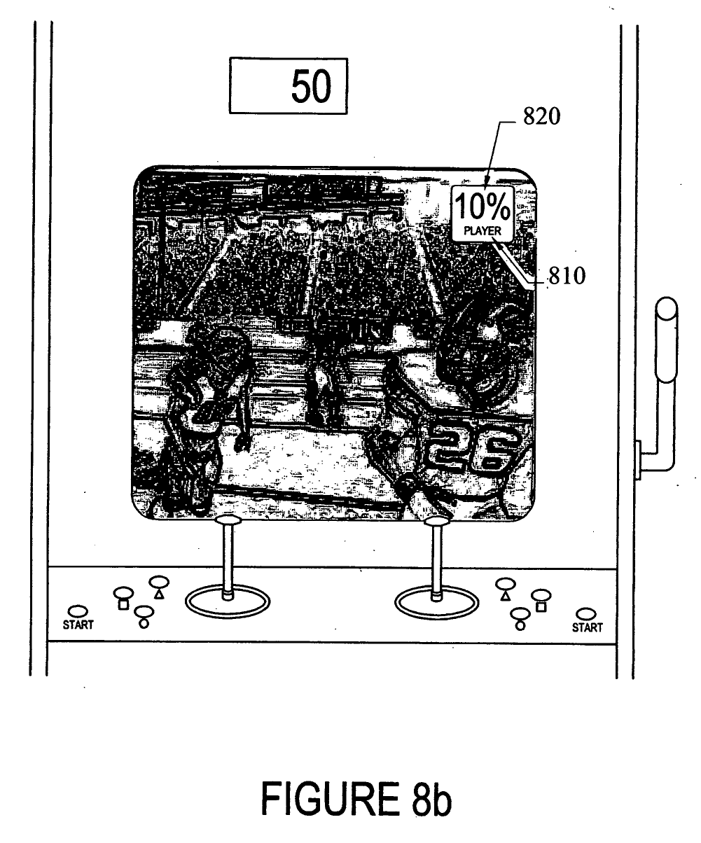

Once the Game Interface Unit has made its adjustments for the Manufacturer's Game Computer's team, player, car or other character, at Step 335 as illustrated by way of example in FIG. 7, Game Interface Unit interfaces with the Monitor Screen and prompts the bettor to press the Start Button located on the Game Control Panel. At Step 337, the bettor presses the Start Button, which signals the Manufacturer's Game Computer to start playing the video game using at least the game playing parameters supplied by the Game Interface Unit, wherein the Manufacturer's Game Computer, otherwise, plays as designed by the Game Manufacturer as illustrated in the embodiment of FIG. 8a. In some embodiments, no changes are made by the Game Interface Unit other than to handicap the skill level as described above, whereby all game controls, graphics, sound effects remain the same.

In games where points scored are the sole determining factor of who wins the game a typical Madden Football 2004 graphic as illustrated in FIG. 8a as a small box in the right hand corner of the Monitor Screen, which shows a point spread 805 handicap and the favored player 810, which in the present example is the betting player and not the computer due to the betting scenarios created at Step 315. In the present handicapping system of point spreads, the computer has determined a point spread based on multiplicity of factors some set forth above and other known to those in the art. To win the game in this “point spread” handicapping method, the betting player only has to cover the point spread, in the example of FIG. 8a, the betting player must win by 22 points. However, if the betting player wins by 21 points, the game terminates as a draw and the original betting amount is returned or credited back to the betting player. If the betting player wins the game but only wins by 20 points, for example, the game terminates as a loss because the point spread was not covered by the betting player and the computer, therefore, wins the bet.

Similar to the example shown in FIG. 8a, FIG. 8b illustrates an alternate handicapping example, where the handicap associated with the game difficulty level is a percentage of increased capability 820 handicap for the underdog team's players, and the favored player 810, which in case shown is the betting player not the computer due to the betting scenarios created in Step 315. In the handicapping system example shown, the percentage of skill, performance and ability is determined, likewise, by the computer based on the factors discussed in connection with the betting scenario established in Step 315. The present example generally applies to video games where points are the sole determining factor of who wins the game. Increased capability 820 handicap corresponds to handicap 670 illustrated in FIG. 6b. Under the present percentage handicap scheme, to win the game, if favored, the betting player has to defeat the opposing team who's players have an advantageous physical increase in speed, strength, skill and other physical abilities of 10% as shown, by way of example and not limitation. Moreover, to win the payout at the end of the game the bettor must have scored 1 point more than the opponent(s). It should be noted that there are no point spreads like that shown in FIG. 8a in this handicapping scenario.

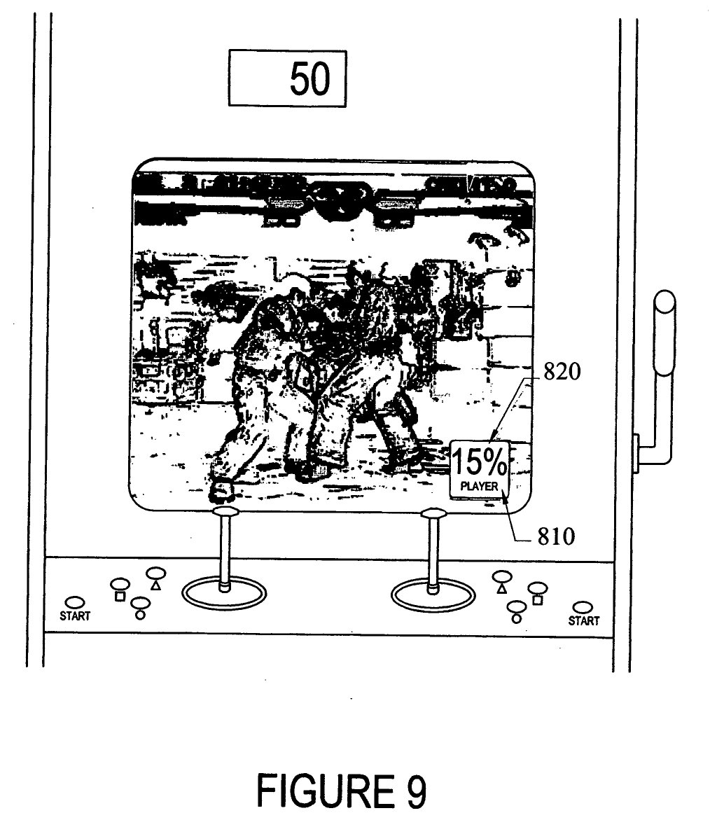

FIG. 9 illustrates an example of a game where the determining factor of who wins the game is based on defeating the other player in physical combat or by surviving with more life force or some other metric. This example shows a fighting game graphic with a small box in the lower right hand corner similar as in the previous examples, showing increased capability 820 and favored player 810. In the upper right and left corners are the life force indicators, which indicate the remaining life force for each player during a match, or afterwards when no particular fighter defeated another player by knockout. In this handicapping system the percentage of increased capability 820 is determined as in the previous examples. To win the game, if favored, the betting player has to defeat the opposing player who has a physical increase in speed, strength, skill, life force and other physical abilities of 15% as shown by way of example in Figure. To win the match or game, the player must either defeat the opposing player by knockout or finish the match with more remaining life force.

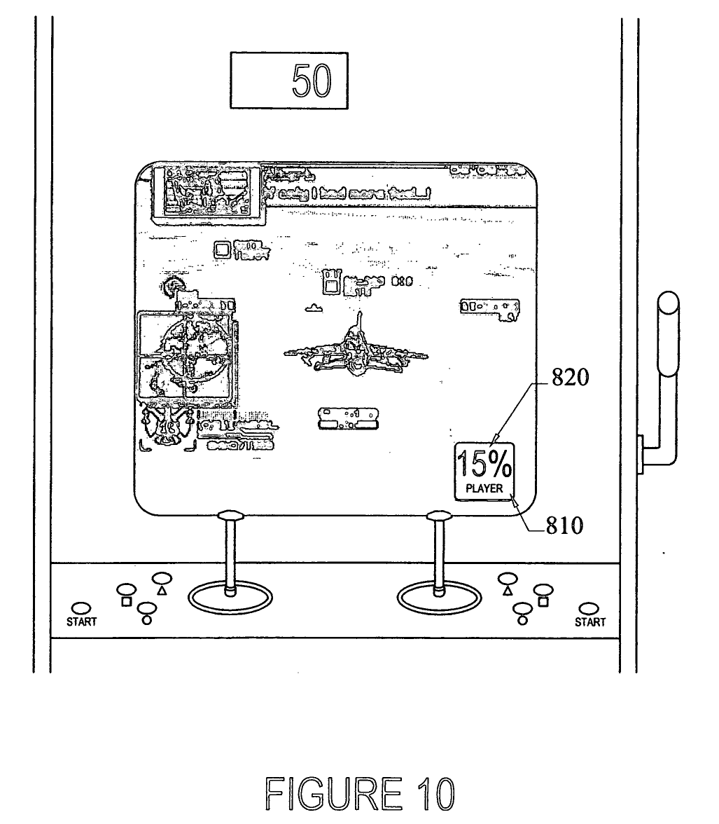

FIG. 10 illustrates a video game where the determining factors of who wins the game is based on survival or completing a mission or other measuring system. In the Figure, an Air Combat game graphic is shown with a small box in the lower right hand corner as in the previous examples. In this example, percentage of increased capability 820 dictates the performance and ability of the underdog player, equipment levels, weapons, supporting aircraft or other factors as designed by the game designers. To win the game, in this example, if favored, the betting player has to complete the mission against an opponent that has a 15% increase in defending aircraft, an aircraft with a 15% increase in speed, agility, weapons etc., and an additional 15% increase in ground defense protecting the target or other mission target that the betting player must defeat or destroy in order to move on to the next level or win the game, and thereby win the payout.

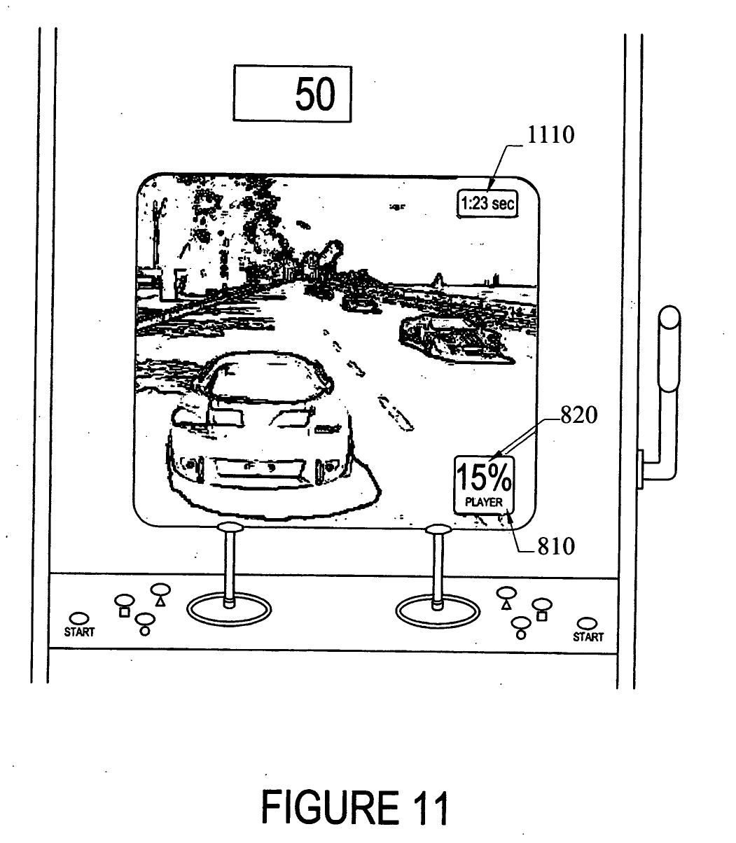

FIG. 11 illustrates a video game where the determining factor of who wins the game is based on beating the opponent by a certain amount of time. This example shows an automobile-racing graphic with a small box in the lower right hand corner as in the previous examples. In the upper right hand corner is the time handicap 1110 that the favored player must defeat the underdog by to win the game. In this example, the favored betting player has to win the race not only before time handicap 1110, but competes with the additional handicap that the opponent has an increase, 15% in the example shown, in skill, ability, equipment performance, additional automobile traffic or other measuring device like fuel, tires etc.

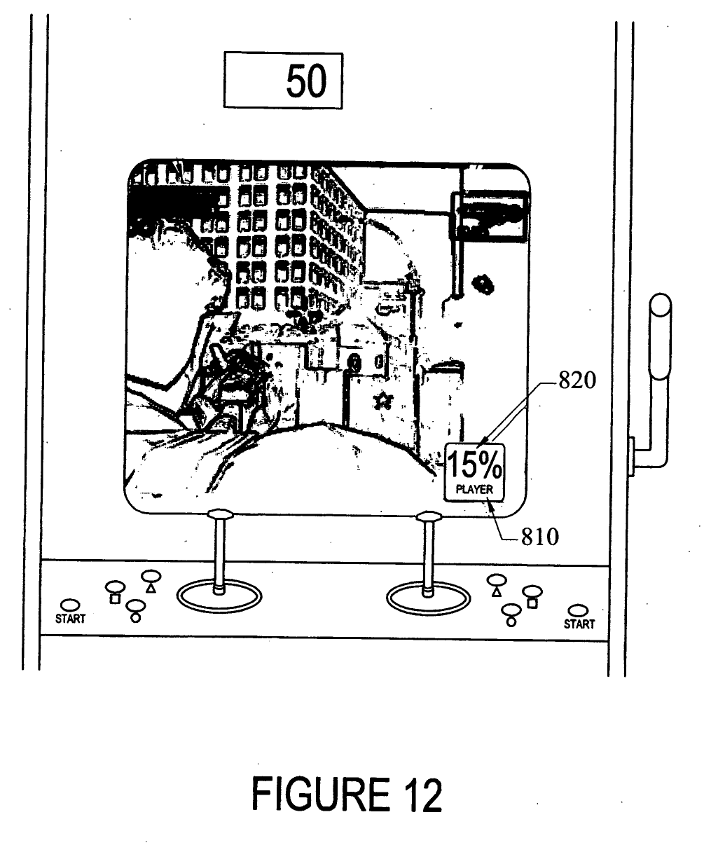

FIG. 12 illustrates a video game example where the determining factor of who wins the game is based on defeating the other player with weapons by surviving with more life force or other metric system. In the Figure, the example shows a first person shooting game graphic with a small box in the lower right hand corner similar to that the previous examples. In the upper left corner are the life force bars. In the upper right hand corner, a display shows the particular goal the player needs to acquire, such as an additional weapon, to help complete the mission, goal or task, as defined by the original video game's design. In the present handicapping example, and similar to the previous examples, the handicapping scheme, such as the percentage of skill, performance, amount of life force, number of goals, weapons, opponent forces etc. are established by the computer at Step 320. To win the game, if favored, the betting player has to defeat a opposing player who has a physical increase in speed, strength, skill, life force, weapons, opponent forces and other physical abilities corresponding to increased capability 820, which is shown as an exemplary 15% in the Figure. In the present example, to win the match or game, and thereby win the payout, the player must either defeat the opposing player by killing all of the opposing forces, complete the mission or finish the match with more remaining life force or other metric.

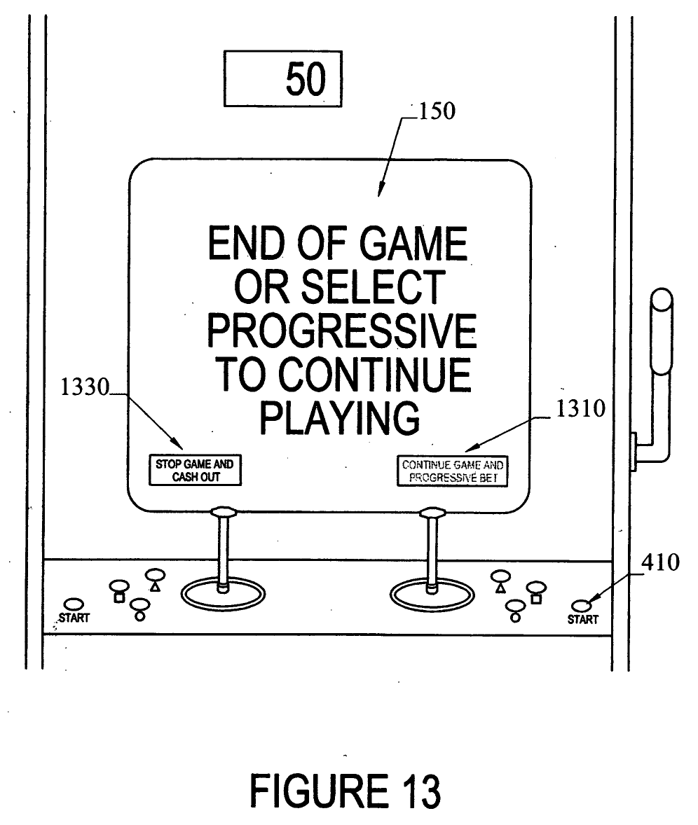

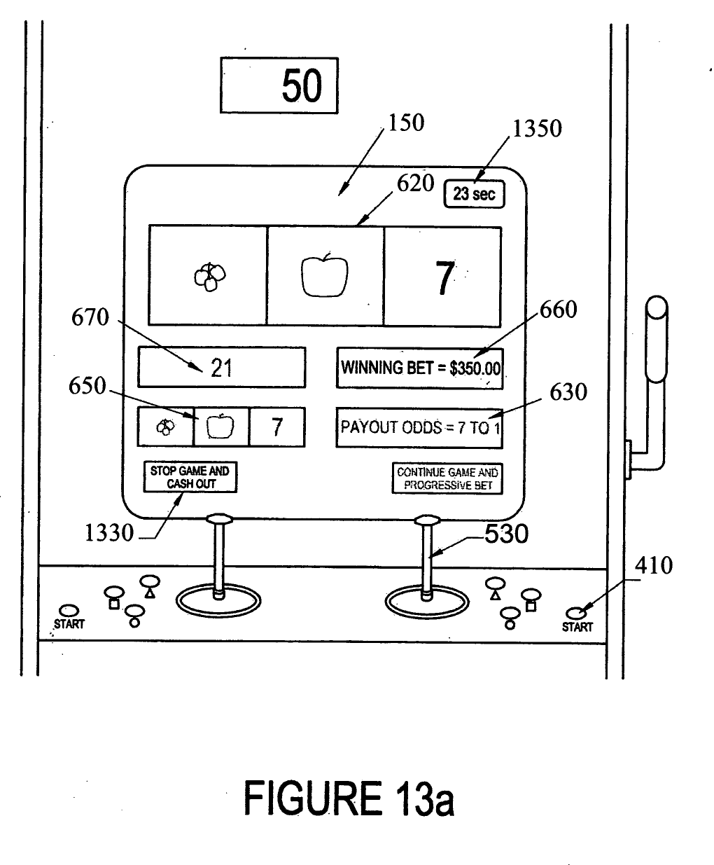

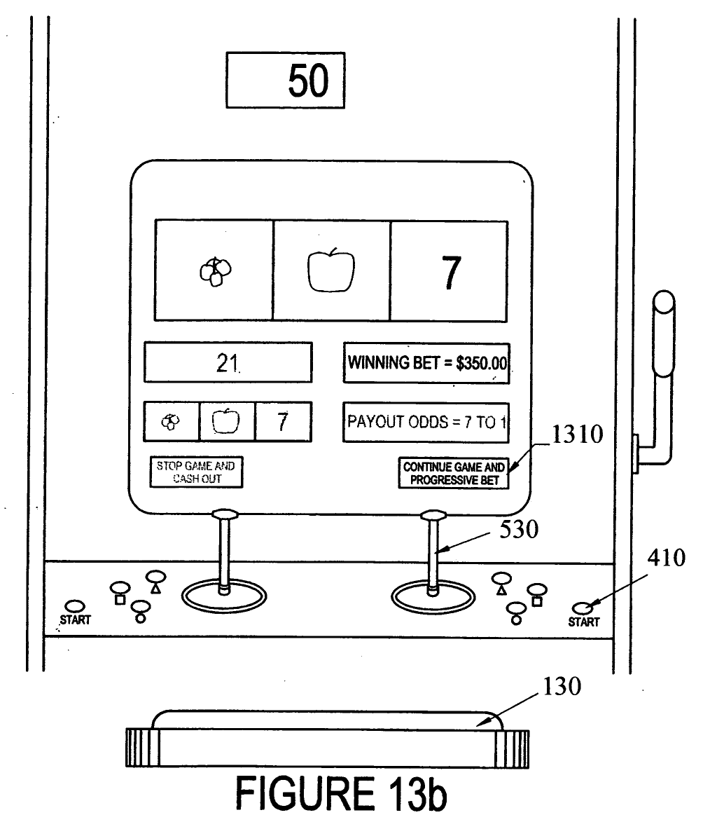

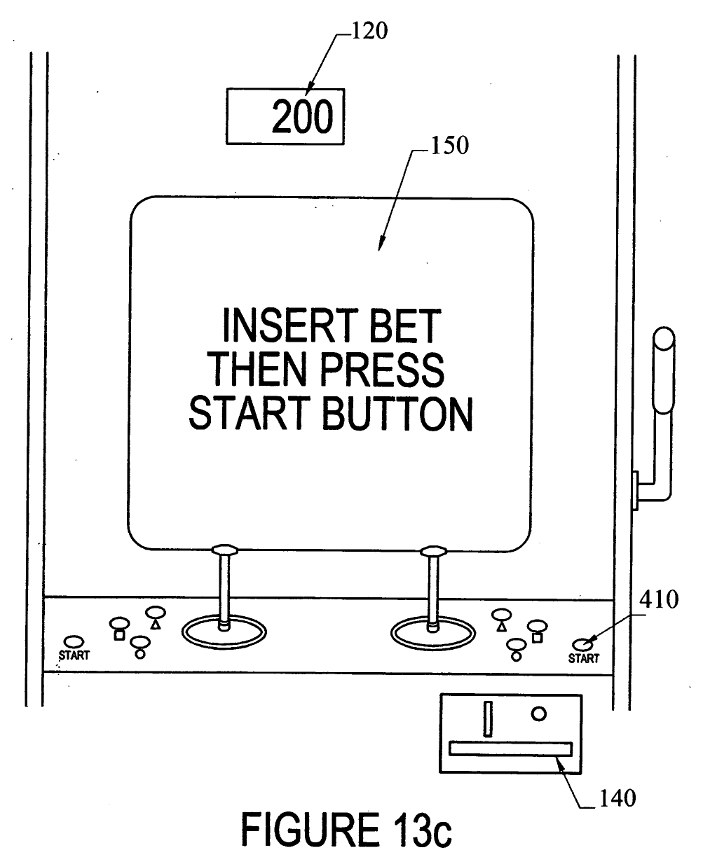

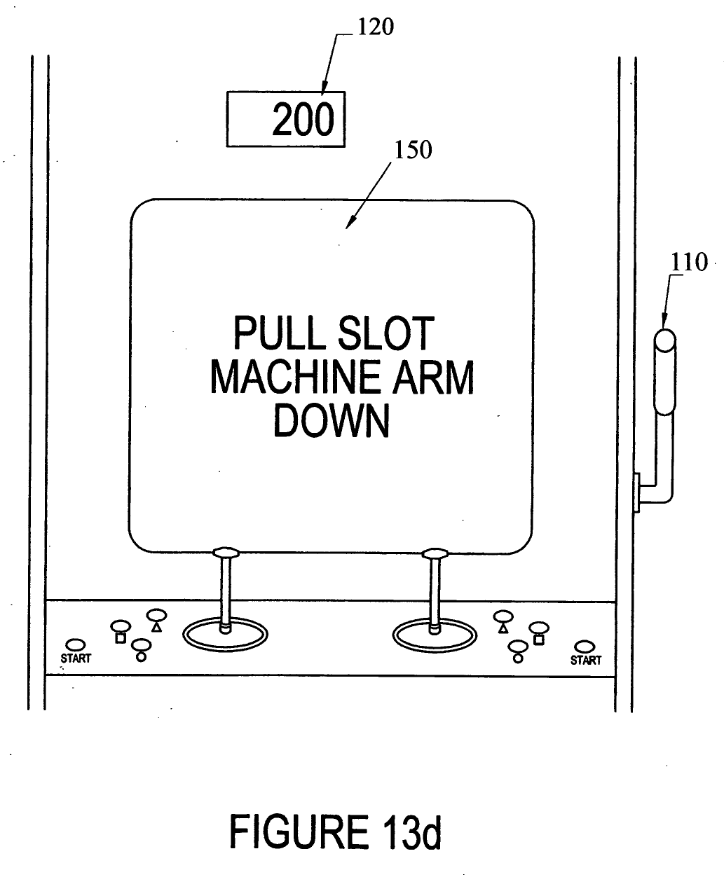

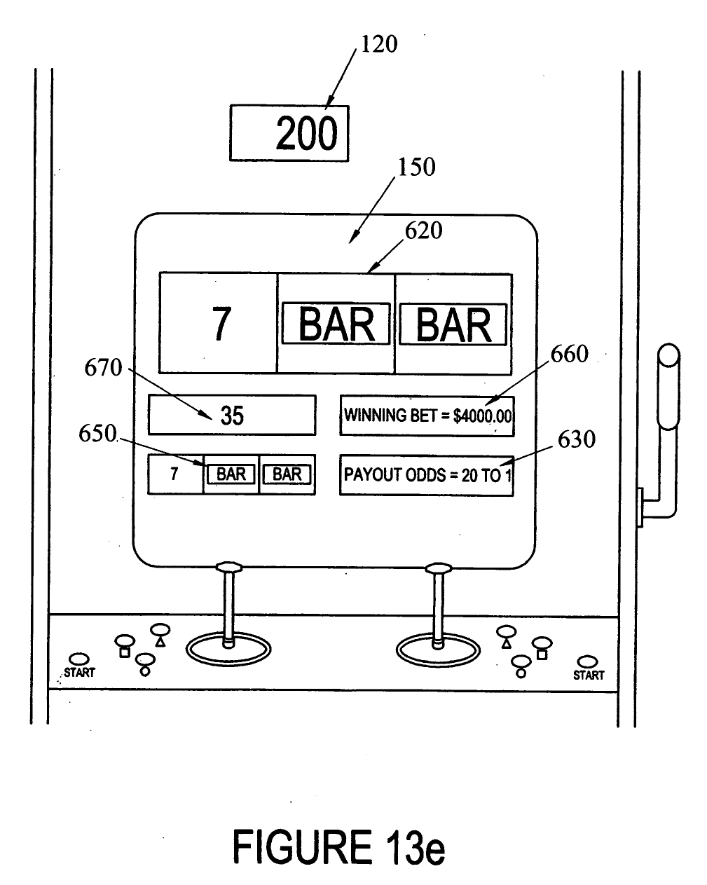

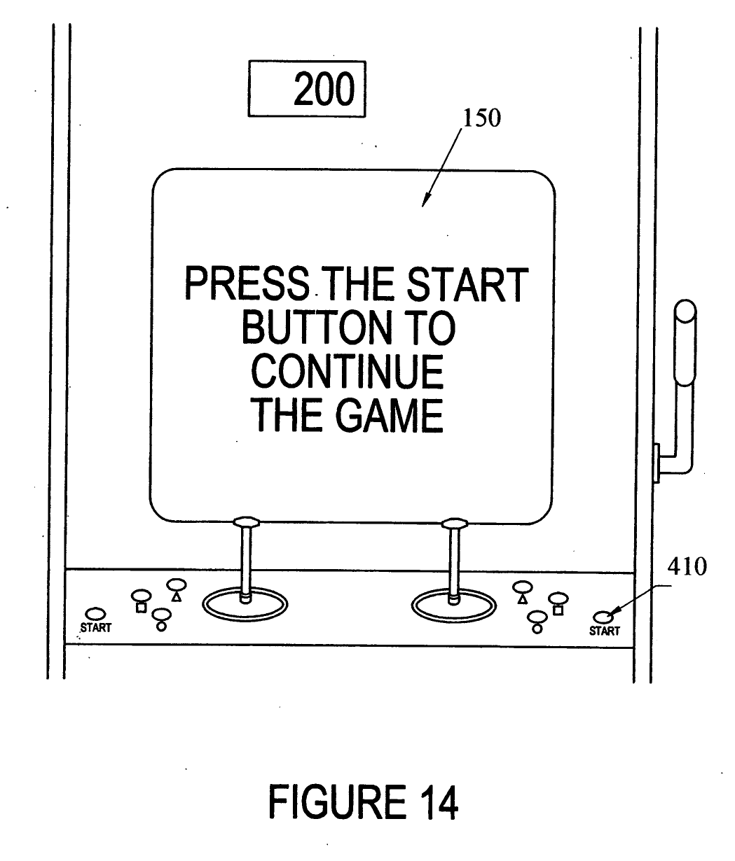

Continuing with the present football video game example, at the end of the first quarter, or an appropriate ending period, as illustrated in FIG. 13 according to an embodiment of the present invention, the Game Interface Unit interfaces with the Monitor Screen 150 to display an end of game prompt, which communicates to the bettor that the video game play has terminated and certain options are available that depend on whether the bettor is winning or losing at this point. If the bettor is winning, two mutually exclusive options are available to select from. There is a multiplicity of suitable methods to handle the case where the bettor has a losing position. In one embodiment (not shown), if the bettor is losing at Step 340, the only option presented is to stop playing the present video game, and return to Step 300, whereby progressive betting feature 1310 is disabled. Other embodiments may instead provide the bettor an option to continue playing from the same point in the previous game, but may require a new bet and return to Step 325 instead of Step 300. If the bettor is winning, at Step 350, the options of selecting a progressive betting feature 1310 or a stop playing, and cash out, feature 1330 are present. The situation shown in the Figure assumes the bettor is winning and selected the stop playing, and cash out, feature 1330, whereby progressive betting feature 1310 is shown as grayed out. Those in the art will readily recognize a multiplicity of suitable variations to the present embodiment. By way of example, and not limitation, in video games that do not have football style time segments in the game, other milestone events particular to the game would be substituted accordingly. Moreover, alternative embodiments are contemplated that implement known betting continuation and/or termination schemes, or may simply end without offering follow on betting continuation schemes even if the bettor is winning. Those in the art will recognize a multiplicity of alternative variations depending on the needs and goals of the particular application. It should also be appreciated that the delay to displaying the present options and the amount of time before proceeding to the next step depends on the particular application.

The embodiment illustrated in FIG. 13a depicts an example screen shot of a “continue or cash out?” prompt that is presented at Step 350 if the bettor is winning in accordance with an embodiment of the present invention. In the Figure, the Game Interface Unit prompts the player to select either progressive betting feature 1310 or stop playing, and cash out, feature 1330. Some embodiments may require the bettor to make a section within a desired time limit, shown as decision time limit 1350 with 23 seconds by way of example. However, other embodiments may implement other standard approaches know to those in the art. In the present embodiment, if the bettor is winning and selects the stop playing, and cash out, feature 1330, Game Interface Unit 135 causes a multiplicity of windows do be displayed, such as, by way of example and not limitation: payout odds 630; point spread 805 (or any handicap 670- see FIG. 6); slot machine Reels 620, which may show the original reel configuration of the betting odds used to determine payout amount 660; and payout amount 660, which is the total of the winning bet to be collected in payout tray 130 (see FIG. 1). Those in the art will recognize other embodiments that may show betting and/or video game information that is specific to the particular application.

If at Step 350 the bettor selects stop playing, and cash out, feature 1330, then Arcade Game Slot Machine console 100 of FIG. 1 pays out, at Step 360, payout amount 660 in payout tray 130, or, otherwise, suitably transfers payout amount 660 to the bettor, for example and not by limitation, by electronic funds transfer means. However, if the bettor selects progressive betting feature 1310 (for example, by pressing the Start Button before decision time limit 1350 runs out) as illustrated by way of example in the embodiments of FIG. 13b and c, the Game Interface Unit at Step 370 will cause to display on the Monitor Screen 150 a prompt to place another cash bet, or progressive bet, into payment acceptor 140 (see FIG. 1) until a desired bet is placed, which is thereafter shown on credit meter 120. In the present embodiment, the process returns to Step 325 with the exception that previous game initialization parameters are used instead selecting new ones at Step 320. Alternative embodiments may return to Step 320 or some other suitable conventional gambling or video game continuation approaches that depending on the particular application, which those in the art will readily adapt according to the present teachings. Assuming a return to Step 320, after the desired bet is placed, the Game Interface Unit causes the bettor to be prompted to initiate gambling game unit 220 (See FIG. 2). By way of example, and not limitation, the initiation by the bettor could be the pulling of pull arm 110 of a Slot Machine gambling game unit embodiment as shown by way of example in the embodiment of FIG. 13d. The Game Interface Unit causes gambling game unit 220 to calculate new odds based on the betting and game specific factors, including, for example the amount of the new bet placed, the existing teams that played in the previous first quarter or other time period, the score or elapsed time or any other metric, and gambling game results as described for Step 330. FIG. 13e illustrates and exemplary screen shot displaying the new odds and related gambling information according to an embodiment of the present invention. Again, skilled artisans will recognize many alternate embodiments that implement known betting game continuation schemes that are suitable for the particular video game application.

The progressive betting feature of the present invention may be repeated any number of times or as may be determined by the particular video game (i.e., the Manufacturer's Computer Game Unit) that is adapted according to the teachings of the present invention. By way of example, and not limitation, in a Football embodiment the progressive betting feature could be continued each quarter until the end of the 4^{th} quarter, and if the game is tied at the end of normal time, the progressive betting feature could continued into overtime until a winner is determined. Embodiments implementing other video game genre will have their appropriate implementation of the present progressive betting feature, which will be readily configured properly by those skilled in the art. For example, and not by way of limitation, the progressive betting feature could be based on a certain time period for fighting, racing, shooting games, and the like. Those skilled in the art will appreciate that all betting and video game system parameters are completely configurable by the system designer according to known principles and methods. Moreover, those skilled in the art will readily recognize that the steps shown by way of example in FIGS. 3a and 3b may be altered in any number of ways including skipping some, adding others, or changing their order as dictated by the nature particular application. Such variations are contemplated as within the scope of the present invention.

Those skilled in the art will further recognize that the foregoing teachings and embodiments directed to adapting a commercial-grade video arcade console may be readily applied to similarly adapting Internet based game servers, personal computer video games, and dedicated computer game consoles to implement gambling adapted video games in accordance with the principles of the present invention. For example, in embodiments, where it is not convenient to have a slot machine pull arm, a standard video button may be configured to properly as a replacement. Similarly, in embodiments where it is not convenient to have a payout tray or payment acceptor, known electronic funds credit and debit transfer means may be used, respectively, instead. Furthermore, it should be understood that although the Game Interface Unit was shown as separate from the Manufacturer's Computer Game Unit, some embodiments might commingle these functional components into one hardware/software system by the manufacture, for example. In yet other embodiments, an existing Manufacturer's Computer Game Unit may be properly retrofitted with the Game Interface Unit and gambling game unit. Similarly, some implementations may use the infrastructure of one video game platform, and include a Manufacturer's Computer Game Unit from another video game platform, possibly as a replacement of the original one. By way of example, and not limitation, a video game platform, or the necessary parts thereof, such as a dedicated computer game console may be configured to be incorporated within a commercial grade video arcade platform (possibly replacing the Manufacturer's Computer Game Unit within the video arcade platform if retrofitted thereon) to implement an Arcade Game Slot Machine console as taught by the present invention. Likewise, any existing and suitable video game software may be run on such a platform. It should also be appreciated that some alternative embodiments, may implement the Game Interface and/or gambling game units remotely from the Manufacturer's Computer Game Unit and use communication line to implement the present invention; by way of example, and not limitation, remote servers over the Internet.

Having fully described at least one embodiment of the present invention, other equivalent or alternative methods of implementing entertainment-oriented video games that include payouts based on chance according to the present invention will be apparent to those skilled in the art. The invention has been described above by way of illustration, and the specific embodiments disclosed are not intended to limit the invention to the particular forms disclosed. For example, the particular implementation of the Game Interface Unit may vary depending upon the particular type of Manufacturer's Computer Game Unit and gambling game unit used. That is, the gambling game unit and Manufacturer's Computer Game Unit described in the foregoing were directed to a slot machine and video arcade game combination; however, similar techniques are applicable to other combinations such as a lotteries, bingo, keno, blackjack, poker, roulette, craps games and Internet based game servers, personal computer video games, or dedicated computer game console implementations of the present invention, which are contemplated as within the scope of the present invention. The multiplicity of alternate gambling game and video game platform implementations is further contemplated to be readily adapted by those in the art to properly interact with all existing video games according to the foregoing teachings that where illustrated by way of example in terms of a football video game embodiment. The invention is thus to cover all modifications, equivalents, and alternatives falling within the spirit and scope of the following claims.

1. A gaming apparatus comprising:
a video game unit;
a gambling game unit; and
a game interface unit configured to be in communication with both the video game unit and the gambling game unit such that the game interface unit can control the playing of the video game unit based on the playing of the gambling game unit, wherein the video game unit or the gambling game unit is configured to pay winnings to a player playing the gaming apparatus based on signals from the game interface unit.

2. The gaming apparatus of claim 1, wherein the video game unit is a video arcade console and the gambling game unit is a slot machine of the mechanical or electronic type.

3. The gaming apparatus of claim 2, wherein the video game unit is configured to comprise the gambling game unit and the game interface unit.

4. The gaming apparatus of claim 1, wherein the video game unit is selected from the group consisting of video arcade consoles, personal computers, Internet game servers, and dedicated computer game consoles.

5. The gaming apparatus of claim 3, wherein the video game unit plays video games from the game genres of sports simulator, flight simulator, point and shoot, or fantasy action.

6. The gaming apparatus of claim 3, wherein the video game unit is configured to communicate with the game interface unit.

7. The gaming apparatus of claim 1, wherein the gambling game unit is configured to communicate with the game interface unit.

8. The gaming apparatus of claim 1, wherein the winnings are paid in cash through a payout tray.

9. The gaming apparatus of claim 1, wherein the winnings are paid to the bettor through electronic means.

10. The gaming apparatus of claim 1, wherein the gambling game unit is selected from the group consisting essentially of lotteries, bingo, keno, blackjack, poker, roulette, craps and slot machines.

11. The gaming apparatus of claim 1, wherein the communication with the video game unit is through the Internet.

12. The gaming apparatus of claim 1, wherein the communication with the video game unit is through a local area network, a wide area network, or wireless.

13. A gaming apparatus comprising:
a commercial-grade video arcade game console;
a slot machine; and
a game interface unit configured to be in communication with both the commercial-grade video arcade game console and the slot machine such that the game interface unit can control the playing of the commercial-grade video arcade game console based on the playing of the slot machine, wherein the commercial-grade video arcade game console is configured to pay winnings to a player playing the gaming apparatus based on signals from the game interface unit.

14. The gaming apparatus of claim 13, wherein the commercial-grade video arcade game console plays video games from the game genres of sports simulator, flight simulator, point and shoot, or fantasy action.

15. The gaming apparatus of claim 13, wherein the commercial-grade video arcade game console is configured to comprise the slot machine and the game interface unit.

16. The gaming apparatus of claim 13, wherein slot machine is of the electronic or mechanical type.

17. The gaming apparatus of claim 13, wherein the winnings are paid in cash through a payout tray.

18. The gaming apparatus of claim 13, wherein the winnings are paid to the bettor through electronic means.

19. The gaming apparatus of claim 13, wherein the commercial-grade video arcade game console is configured to communicate with the game interface unit.

20. The gaming apparatus of claim 13, wherein the slot machine is configured to communicate with the game interface unit.

21. The gaming apparatus of claim 13, wherein the communication between the slot machine or the commercial-grade video arcade game console, and the game interface unit is through a local area network, a wide area network, wireless, or Internet means.

22. A gaming apparatus comprising:
a video game playing means;
a gambling game playing means;
a game interface means configured to be in communication with both the video game means and the gambling game means; and
a winnings payout means.

23. A method of operating a gaming apparatus having a video game and a gambling game comprising the steps of:
a) placing a first bet by a bettor;
b) playing the gambling game to produce an odds;
c) calculating a payout multiple based on at least the odds;
d) configuring at least one video game parameter based at least on the odds;
e) playing the video game by a player; and
f) if the player wins the video game and selects not to continue, paying the bettor winnings based at least on the first bet and the payout multiple.

24. The method of operating a gaming apparatus of claim 23, further comprising the step of selecting a first video game parameter by the bettor, whereby the configuring of at least one video game parameter in (d) is further based on the first video game parameter.

25. The method of operating a gaming apparatus of claim 24, wherein calculating the payout multiple is further based on the first video game parameter.

26. The method of operating a gaming apparatus of claim 23, wherein the winnings is calculated by multiplying the first bet and the payout multiple.

27. The method of operating a gaming apparatus of claim 23, further comprising the step of:
if the player loses the video game ending the video game.

28. The method of operating a gaming apparatus of claim 23, further comprising the step of:
if the player wins the video game and selects to continue, the bettor placing a second bet to continue playing again.

29. The method of operating a gaming apparatus of claim 23, wherein the video game is a video arcade console and the gambling game is a slot machine of the mechanical or electronic type.

30. The method of operating a gaming apparatus of claim 23, wherein the video game is selected from the group consisting essentially of video arcade consoles, personal computers, Internet game servers, and dedicated computer game consoles.

31. The method of operating a gaming apparatus of claim 23, wherein the video game is classified under a sports simulator, flight simulator, point and shoot, or fantasy action game genres.

32. The method of operating a gaming apparatus of claim 23, wherein the gambling game unit is selected from the group consisting essentially of lotteries, bingo, keno, blackjack, poker, roulette, craps and slot machines.

33. A method of operating a gaming apparatus including a commercial-grade video arcade game console for playing a video game and a slot machine comprising the steps of:
a) placing a first bet by a bettor;
b) playing the slot machine to produce an odds;
c) calculating a payout multiple based on at least the odds;
d) configuring at least one video game parameter based at least on the odds;
e) playing the video game by a player; and
f) if the player wins the video game and selects not to continue, paying the bettor winnings based at least on the first bet and the payout multiple.

34. The method of operating a gaming apparatus of claim 33, further comprising the step of selecting a first video game parameter by the bettor, whereby the configuring of at least one video game parameter in (d) is further based on the first video game parameter.

35. The method of operating a gaming apparatus of claim 34, wherein calculating the payout multiple is further based on the first video game parameter.

36. The method of operating a gaming apparatus of claim 33, wherein the winnings is calculated by multiplying the first bet and the payout multiple.

37. The method of operating a gaming apparatus of claim 33, wherein the winnings are paid in cash through a payout tray.

38. The method of operating a gaming apparatus of claim 33, wherein the winnings are paid to the bettor through electronic means.

39. The method of operating a gaming apparatus of claim 33, further comprising the step of:
ending the video game if the player loses the video game.

40. The method of operating a gaming apparatus of claim 33, further comprising the step of:
if the player wins the video game and selects to continue, the bettor placing a second bet to continue playing again.

41. The method of operating a gaming apparatus of claim 33, wherein the video game is classified under a sports simulator, flight simulator, point and shoot, or fantasy action game genres.
